(19) United States
(12) Patent Application Publication
(10) Pub. No.: US 2014/0177735 A1
(43) Pub. Date: Jun. 26, 2014

(54) IMAGE RECEIVING DEVICE AND IMAGE RECEIVING METHOD

(71) Applicants: Tomoyuki Nonaka, Tokyo (JP); Nobuaki Kabuto, Tokyo (JP); Hironori Komi, Tokyo (JP); Keisuke Inata, Tokyo (JP)

(72) Inventors: Tomoyuki Nonaka, Tokyo (JP); Nobuaki Kabuto, Tokyo (JP); Hironori Komi, Tokyo (JP); Keisuke Inata, Tokyo (JP)

(73) Assignee: HITACHI MAXELL, LTD., Osaka (JP)

(21) Appl. No.: 14/113,625

(22) PCT Filed: Apr. 25, 2012
(86) PCT No.: PCT/JP2012/061084

§ 371 Date: Nov. 25, 2013

(30) Foreign Application Priority Data
Apr. 27, 2011 (JP) 2011-098950

(51) Int. Cl. H04N 19/91

(52) U.S. Cl. CPC H04N 19/00987
USPC 375/240.27

(57) ABSTRACT

An image transmission device compresses and transmits image data to be sent and cannot correct errors occurring on the transmission path when image data to be transmitted is larger than a currently prescribed image size. In an image receiving device which receives compressed image data, data to be inputted is inputted by switching between first periods, during which the amount of data transmitted per prescribed time interval is a first data transmission amount, and second periods, during which the amount of data transmitted per prescribed time interval is less than the first data transmission amount. Compressed image data is inputted during the first periods, and error correction codes are inputted during the second periods, and a control unit expands the output of an error detection unit by means of an expansion unit and outputs the same.

### INCORPORATION BY REFERENCE

This application claims priority of Japanese Patent Application Ser. No. 2011-098950, filed Apr. 27, 2011, the entire content of which is incorporated herein by reference.

### TECHNICAL FIELD

The technical field relates to transmission and reception of image information.

### BACKGROUND ART

In recent years, the number of pixels to be treated by digital image processing is increasing, year by year, in accordance with the ongoing quest for HD (High Definition: 1920×1080 pixels) of broadcasting and the quest for higher pixelization of image sensors.

Concerning the technique for transmitting these image data between devices, there are HDMI (High-Definition Multimedia Interface (Registered Trademark No. 2664032)) standard, DisplayPort (Trademark) standard formulated by the VESA (Video Electronics Standards Association) and the like.

In the above-stated HDMI data transmission technique, Patent Literature 1 discloses that “the device is the one that selectively sends a non-compressed video signal or a compressed video signal which was obtained by applying compression processing to this non-compressed video signal by use of a reception device-handleable compression scheme, and is capable of nicely transmitting a video signal of a desired bit rate within the transfer bit rate of a transmission path” (see Patent Literature 1, [0048]) and, regarding the compression scheme, discloses that “a respective one of data compression units 121-1 to 121-n applies compression processing, with a predetermined compression ratio, to a non-compressed video signal which was outputted from a codec 117 and outputs a compressed video signal. Data compression units 121-1 to 121-n constitute a video signal compressor unit. Data compression units 121-1 to 121-n perform data compression processing operations by different compression schemes, respectively. Currently available examples of the compression scheme include RLE (Run Length Encoding), Wavelet, SBM (SuperBit Mapping (Registered Trademark No. 3284640)), and LLVC (Low Latency Video Codec) and ZIP” (see Patent Literature 1, [0077]).

Additionally, in the HDMI, image data are recommended to use the data transmission format of TMDS (Transition Minimized Differential Signaling (Registered Trademark No. 4755037) technology, as one example of which is shown in Patent Literature 2.

### CITATION LIST

### Patent Literatures

Patent Literature 1: JP-A-2009-213110

Patent Literature 2: Japanese Patent Application (JPA) No. 2003-559136

### SUMMARY OF INVENTION

### Technical Problem

However, any one of these citations does not take into consideration the transmission of an image (also called the “video”: the same will be true in the following description) data with a larger size.

### Solution to Problem

To solve the aforementioned problem, configurations recited in the appended claims are employed, for example.

While this application includes a plurality of means for solving the problem, one example thereof is as follows: in an image receiving device which receives a compressed image data, this device is arranged to have an input unit which receives the compressed image data and an error correction code, an error detection code computation unit which computes an error correction code from the compressed image data, an error detection unit which compares the received error correction code and an output of the error detection code computation unit and which performs correction after having detected an error, an expansion unit which expands the compressed image data to be output from the error detection code computation unit, an output unit which outputs the expanded image data which was expanded by the expansion unit, and a control unit which controls the input unit, the error detection code computation unit, the error detection unit, the expansion unit and the output unit, wherein data to be inputted is inputted by switching between first periods, during which the amount of data transmitted per prescribed time interval is a first data transmission amount, and second periods, during which the amount of data transmitted per prescribed time interval is less than the first data transmission amount. Compressed image data is inputted during the first periods, and error correction codes are inputted during the second periods, and a control unit expands the output of an error detection unit by means of an expansion unit and outputs the same.

### Advantageous Effects of Invention

In accordance with the above-stated means, it becomes possible to achieve transmission of image data with larger sizes. Other objects, features and advantages of the present invention will be apparent from the following more particular description of embodiments of the invention, as illustrated in the accompanying drawings.

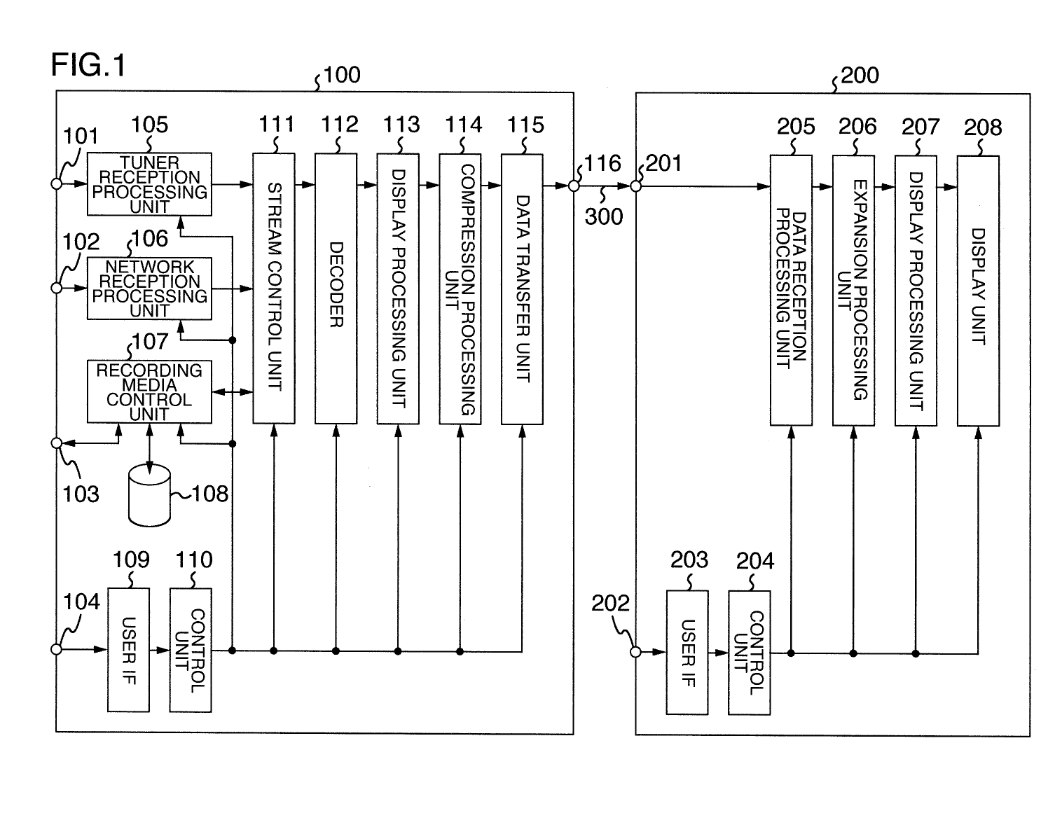

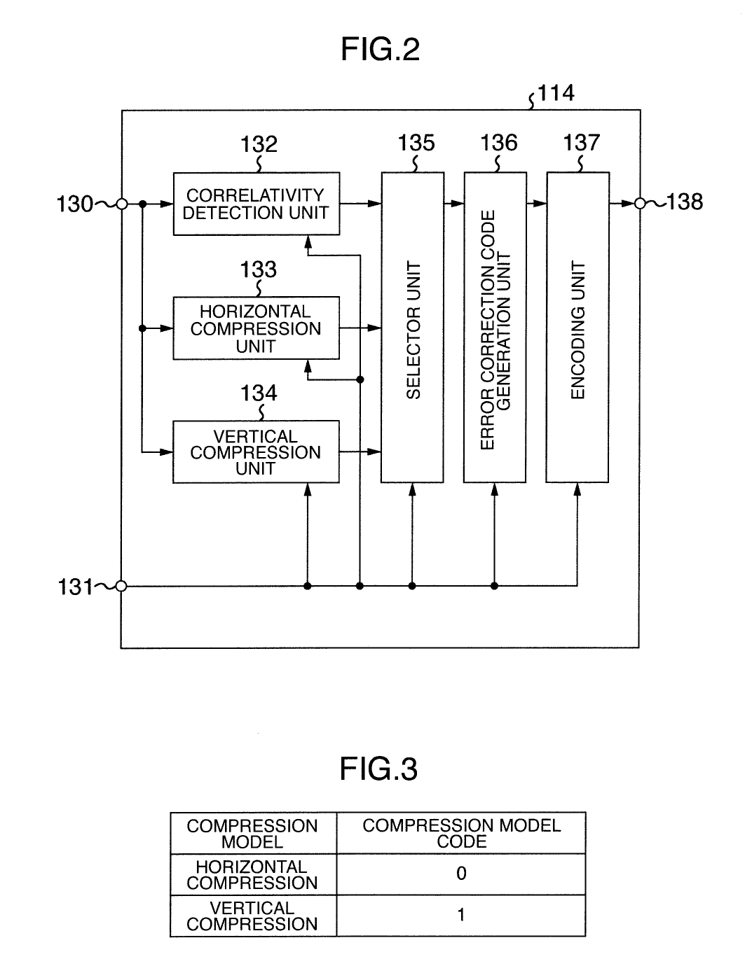

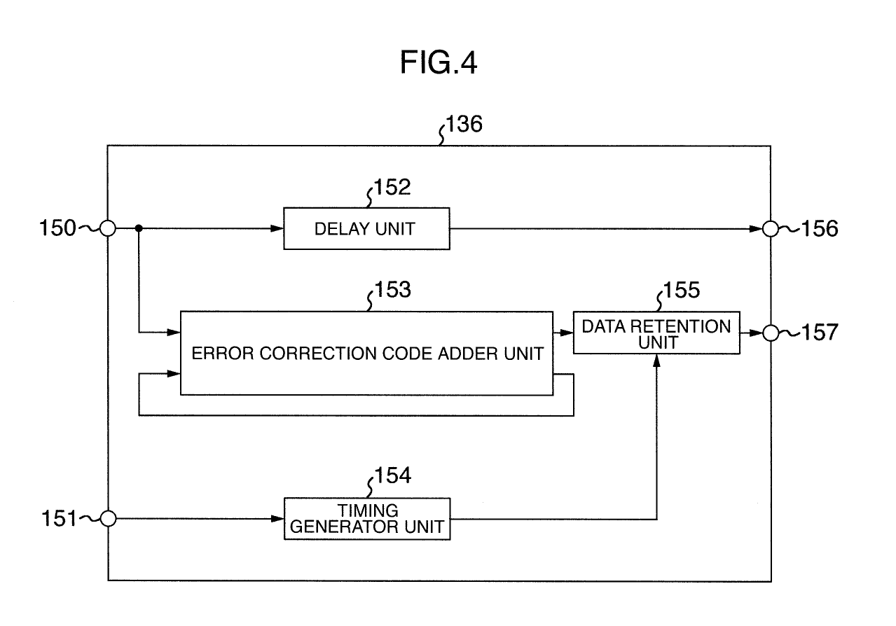

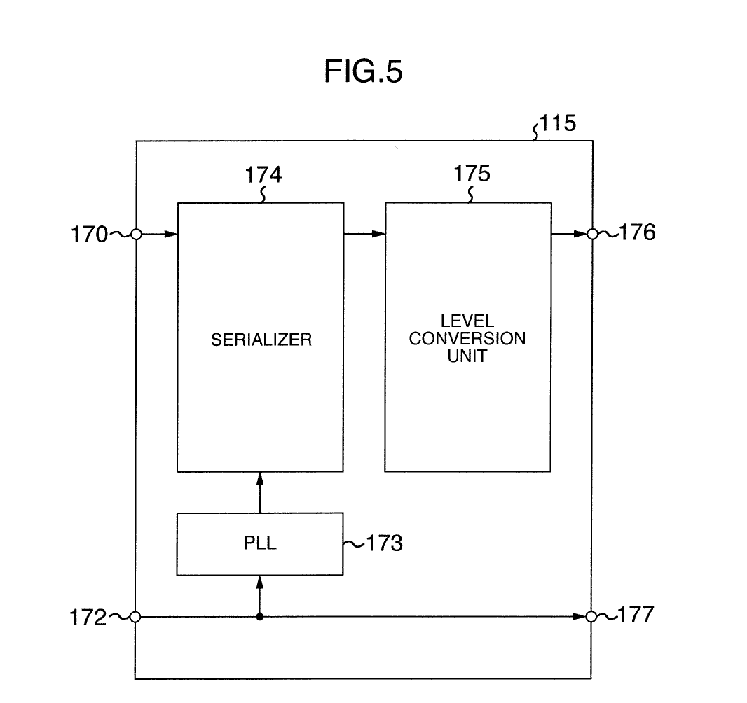

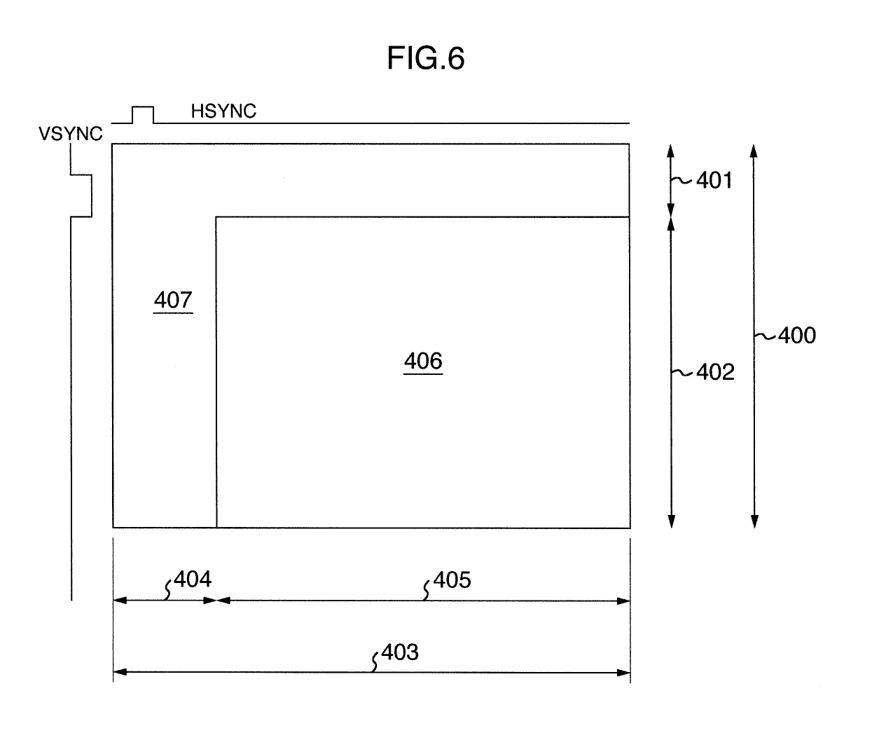

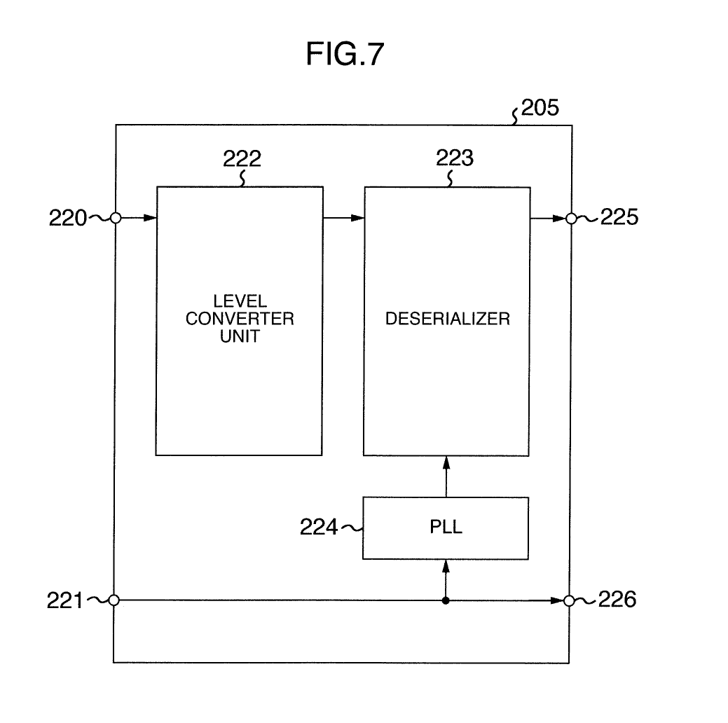

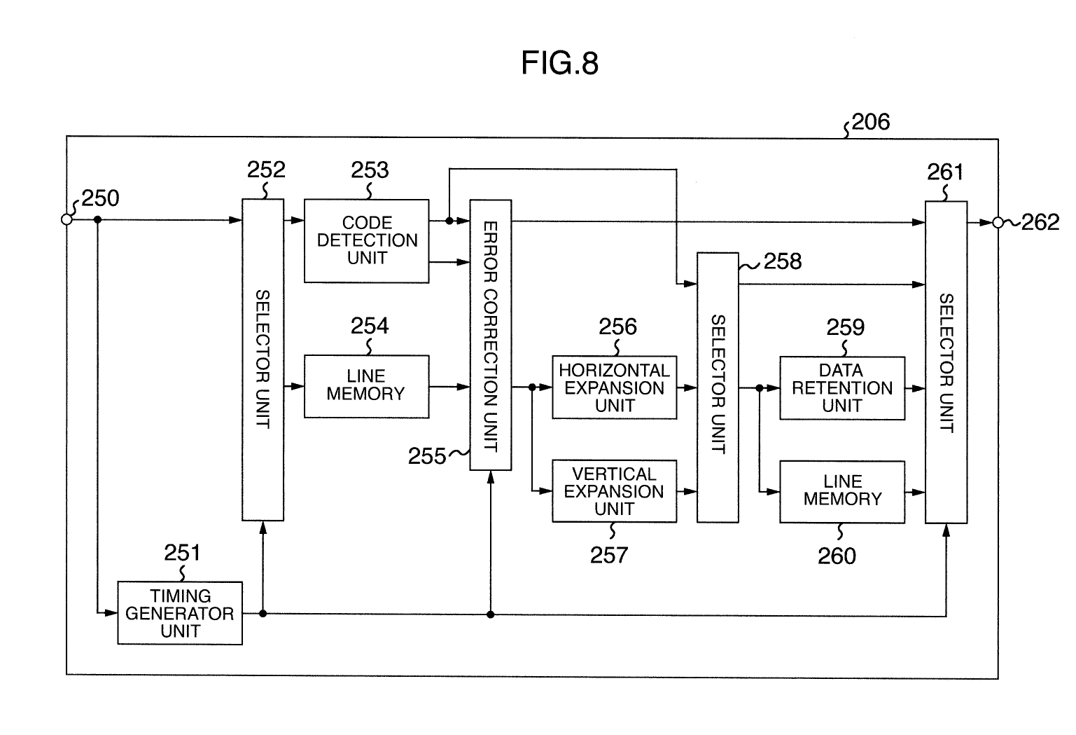

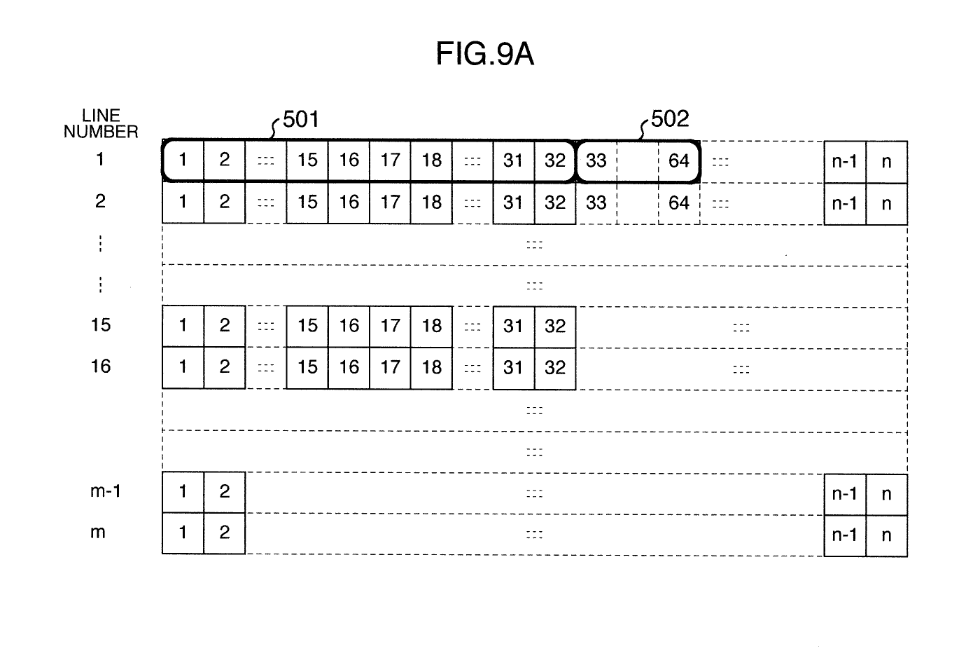

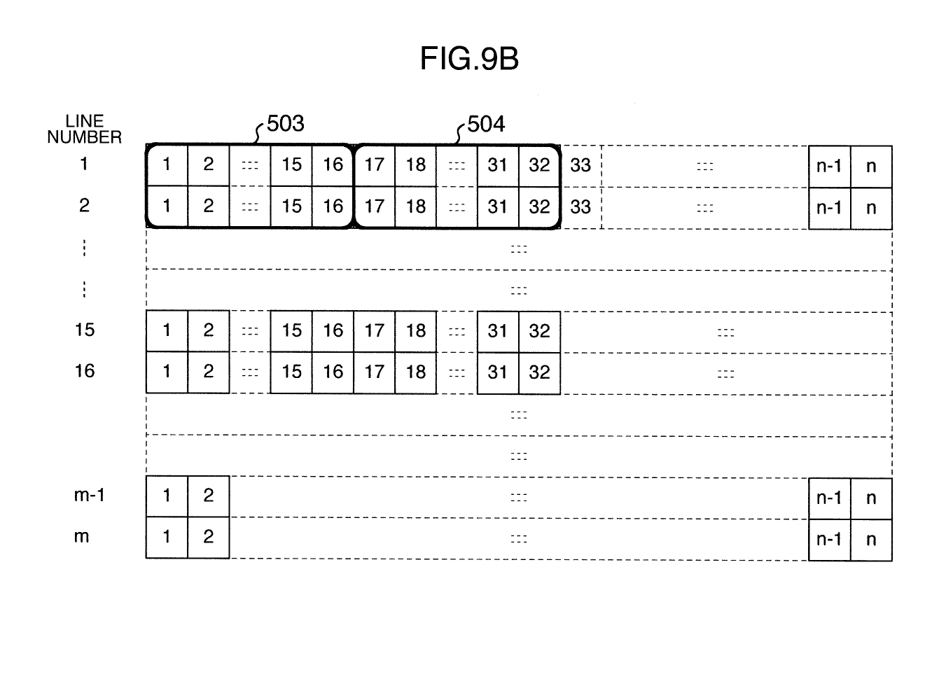

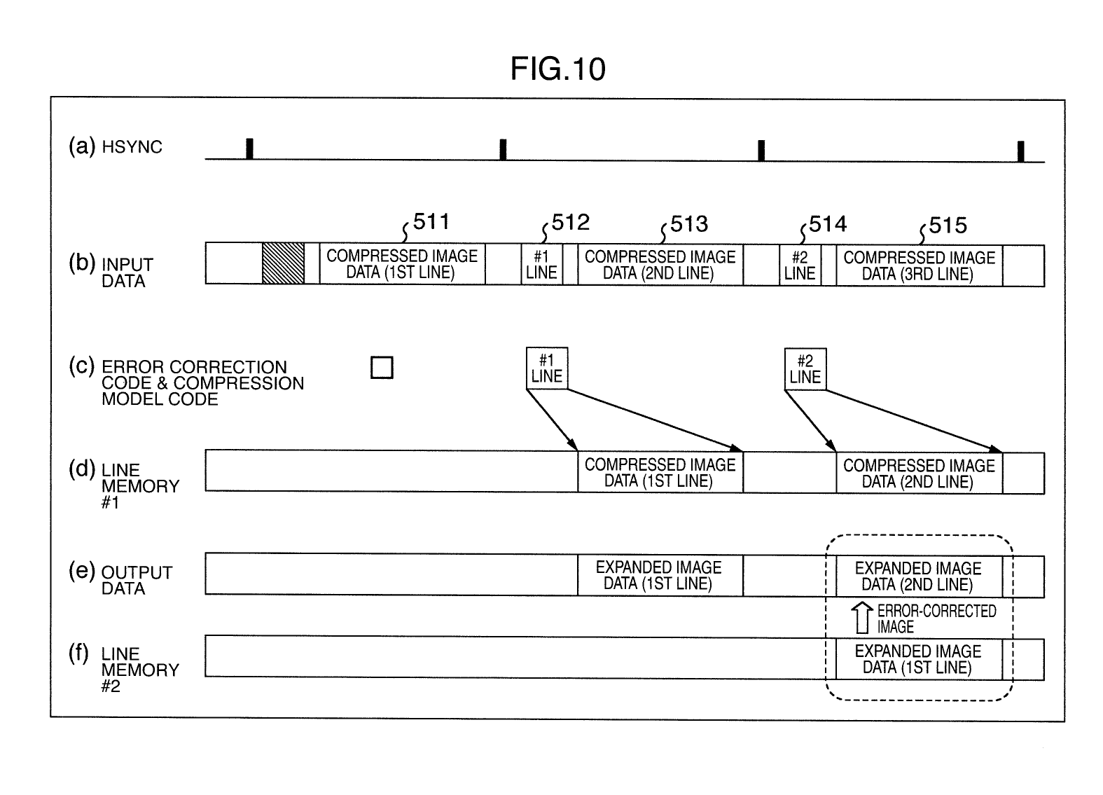

### BRIEF DESCRIPTION OF DRAWINGS

[FIG. 1] One example of an image transmission device and image receiving device.

[FIG. 2] One example of a compression processing unit.

[FIG. 3] Examples of compression model codes.

[FIG. 4] One example of an error correction code generation unit.

[FIG. 5] One example of a data transfer unit.

[FIG. 6] One example of an effective/blanking period of image data.

[FIG. 7] One example of a data reception processing unit.

[FIG. 8] One example of an expansion processing unit.

[FIG. 9A] One example of a unit of image data to be compressed.

[FIG. 9B] One example of a unit of image data to be compressed.

[FIG. 10] One example of a flow diagram showing the concept of expansion processing.

### DESCRIPTION OF EMBODIMENTS

Traditionally, in transmission technology for transmission of image data, in cases where the image data to be sent by an image transmission device is compressed and transmitted to transfer image data with its size being larger than the presently defined image size over the currently defined transfer path or channel, the occurrence of errors on the transfer path has not been taken into consideration. Due to this, even where an error with its size corresponding to one bit occurs on the transfer path, the influence of this error covers a plurality of pixels included in the unit of compression; so, this could result in the risk that many pixels perform erroneous display operations. Embodiments capable of solving this problem will be described using the accompanying drawings below.

### Embodiment 1

A preferred form of an image transmission device and image receiving device in accordance with one embodiment of this invention will be explained below.

FIG. 1 is a block diagram showing an image transmission system of this embodiment, which is configured from an image transmission device 100 and an image reception device 200, which are connected together by a cable 300.

The image transmission device 100 is an image transmission device that compresses and transmits image data, which device is an image recording/reproduction equipment that outputs image data, including image data obtained by decoding a received digital broadcast to enable viewing/listening and camera-shot image data, to another equipment by an HDMI cable or the like. Typical examples of the image transmission device 100 include a recorder, a digital TV with built-in recorder functionality, a personal computer with built-in recorder function, a camcorder, and a cellular or mobile telephone with embedded camera function.

The image reception device 200 is a display equipment that uses an HDMI cable or else to input image data and output the image to a monitor. Examples of the image reception device 200 include a digital TV, display, projector, etc.

The cable 300 is a data transfer path which performs communication of data, such as image data or the like, between equipments of the image transmission device 100 and image reception device 200. One example of the cable 300 is a wire cable having compatibility with the HDMI standard or DisplayPort standard or a data transfer channel for performing wireless data communications.

First of all, a configuration of the image transmission device 100 will be explained.

Input parts 101, 102 and 103 are input sections for inputting image data to the image transmission device 100. One example of image data to be input to the input part 101 is a digital broadcast to be input in the form of an electrical wave coming from a relay station, such as a broadcast station or a broadcasting satellite or the like. To the input part 101, this electric wave from a relay station such as the broadcast station or broadcast satellite is inputted.

Examples of image data to be input to the input part 102 are digital broadcast and information contents to be distributed via a network by use of broadband connections of the Internet.

One example of the image data to be input to the input part 103 is a digital broadcast or digital content which is stored in an external recording media connected to the input part 103. Examples of the external record media coupled to the input part 103 or the record media 108 built in the image transmission device 100 are an optical disc, magnetic disk, semiconductor memory and others.

A tuner reception processing unit 105 is a reception processor unit which converts an input electrical wave into a bit stream, wherein the electric wave of RF (Radio Frequency) band is frequency-converted into an IF (Intermediate Frequency) band, followed by decoding, as a fixed-band signal that does not depend on reception channels, a modulation operation which was applied for transmission to the decoded bit stream.

Examples of the bit stream include but not limited to an MPEG2 transport stream (referred to hereinafter as MPEG2-TS) and a bit stream with its format pursuant to the MPEG2-TS. Bit streams to be presented below will be explained while regarding the MPEG2-TS as a representative.

The above-stated tuner reception processing unit 105 further detects and corrects a code error or errors occurred during transmission, selects a single transponder frequency with a viewing/listening or recording execution program being multiplexed therein after having performed cancellation of scramble for the error-corrected MEG2-TS, and disassembles a bit stream in this selected single transponder into audio and video packets of one program.

The MPEG2-TS from the tuner reception processing unit 105 is supplied to a stream control unit 111. In order to maintain intervals upon receipt of such packets at the tuner reception processing unit 105, the stream control unit 111 detects, from within the received packets, a PTS (Presentation Time Stamp) which is time management information and STC (System Time Clock) of the inside of a reference decoder of MPEG system and then adds a time stamp at the timing that correction was done in response to a detection result. The time stamp-added packet are supplied to either one or both of a decoder 112 and a recording media control unit 107.

A data path of the decoder 112 corresponds to the processing at the time of viewing/listening of image data; a data path of the recording media control unit 107 corresponds to the processing at the time of recording image data on record media. The above-stated stream control unit 111 has another input, which is MPEG2-TS to be input from the input part 102 by way of a network reception processing unit 106. The above-stated data paths are input sections for acquisition of digital broadcasts or digital contents to be distributed via networks.

Further another input of the aforementioned stream control unit 111 is an MPEG2-TS obtained by reading, by the recording media control unit 107, a digital broadcast or digital content being recorded on an external recording media connected to the input part 103 or a record media 108 which is built in the image transmission device 100. The aforesaid stream control unit 111 selects at least one or more of these inputs, and outputs to the decoder 112.

The decoder 112 decodes the MEG2-TS inputted from the stream control unit 111 and outputs its generated image data to a display processing unit 113. The display processing unit 113 applies, for example, OSD (On Screen Display) superimposition processing and expansion or shrinkage processing to the input image data and, thereafter, outputs to a compression processing unit 114.

The compression processing unit 114 applies simple compression processing to the image data entered from the display processing unit 113 and outputs to a data transfer unit 115.

The data transfer unit 115 converts the image data into a signal having its format suitable for cable transmission and performs outputting from an output part 116. One example of the signal of the cable transmission-suited format is recited in the HDMI standard. In HDMI, image data are recommended to employ the data transmission format of TMDS (Transition Minimized Differential Signaling (Registered Trademark No. 4755037)) scheme.

An input part 104 is an input section for input of a signal for controlling an operation of the image transmission device 100. One example of the input part 104 is a signal reception unit of remote controller. A control signal from the input part 104 is supplied to a user IF 109. The user IF 109 outputs the signal supplied from the input part 104 to a control unit 110. The control unit 110 controls an entirety of the image transmission device 100 in accordance with the signal of input part 104. One example of the control unit 110 is a microprocessor or else. An image data from the image transmission device 100 is supplied to the image reception device 200 via cable 300.

A configuration of the image reception device 200 will next be explained.

An input part 201 is for inputting a signal of the format suitable for cable transmission. The signal that was input to the input part 201 is supplied to a data reception processing unit 205.

The data reception processing unit 205 is responsive to the signal of the format suited to cable transmission, for performing predetermined digital data conversion processing and for outputting converted digital data to an expansion processing unit 206.

The expansion processing unit 206 expands the compression processing that was performed by the compression processing unit 114 in the aforesaid image transmission device 100, generates an image data, and outputs it to a display processing unit 207.

The display processing unit 207 applies display processing to the input image data. Examples of the display processing include OSD superimposition processing, expansion/shrinkage processing for conversion to the resolution of display unit 208, and frame rate conversion processing. An output of the display processing unit 207 is outputted to the display unit 208.

The display unit 208 converts the input image data into a signal adapted for a display scheme and displays it on its screen. Examples of the display unit 208 are display devices, such as a liquid crystal display, plasma display, organic EL (Electro-Luminescence) display, etc.

An input part 202 is an input section for inputting a signal for control of an operation of the image receiving device 200. One example of the input part 202 is a signal receiver unit of remote controller or the like. The control signal from the input part 202 is supplied to a user IF 203. This user IF 203 outputs the signal that is from the input part 202 to a control unit 204. The control unit 204 is a control section which controls an entirety of the image reception device 200 in accordance with the signal of input part 202.

FIG. 2 is a block diagram showing one example of a configuration of the compression processing unit 114.

An input part 130 is an input section for inputting an image data to the compression processing unit 114. The input image data is supplied to a correlativity detection unit 132, horizontal compression unit 133 and vertical compression unit 134.

FIGS. 9A and 9B are diagrams showing examples of the image data to be input to the input part 130. Each diagram shows a brightness or luminance signal having “n” pixels in the horizontal direction and “m” lines in vertical direction. A color difference signal is the same in format as the luminance signal in the case of the 444 format. Examples of the pixel number n and line number m include what is called the frill HD image with n=1920 and m=1080, the so-called “4k2k” image with n=3840 and m=2160.

Assume here that the unit of the image data to be compressed by the compression processing unit 114 is set to I pixels in the horizontal direction and k pixels in the vertical direction. Numerals 501 and 502 indicate examples with I=32 and k=1, each of which consists of continuous 32-pixel data within the same line. The unit of this image data is compressed by the horizontal compression unit 133.

On the other hand, 503 and 504 indicate examples with I=16 and k=2, each of which consists of a data of 16 pixels continuing between two upper and lower lines. The unit of this image data is compressed by the vertical compression unit 134. More specifically, image data units of k1 and k2 (k1<k2) are provided which are different from each other in k pixel number in vertical direction, and the horizontal compression unit 133 compresses the k1-image data unit whereas the vertical compression unit 134 compresses the k2-image data unit.

An increase in k results in an increase in line memory capacity, causing the circuit cost to increase accordingly. This leads to an increase in processing time interval, which becomes the cause of a delay in on-screen display of video images. In the following explanation, an example will be used which has the settings of k1=1 and k2=2 to thereby reduce the cost and processing time interval. In addition to the horizontal compression unit 133 and vertical compression unit 134, a compression processing unit having a different k3 may be further provided, for permitting selective use of outputs of three or more compressor units, thus making it possible to further increase the compression efficiency.

In the case of a color difference signal having the 422 format, it becomes data with U components and V components of the color difference signal being nested on a per-pixel basis. In the case of 4k2k, for example, U and V components may be joined together and handled as an image data with n=3840 and m=2160. Generally, a group of only U components or only V components is high in correlativity; so, U components and V components are separately handled as n=960 and m=1080 whereby only the same components are used to provide the unit of an image data to be compressed, thereby enabling enhancement of the is compression efficiency.

The correlativity detection unit 132 computes the image data's frequency components in the horizontal and vertical directions and detects which one of these frequency components exhibits higher correlativity. Concerning the correlativity detection, other approaches than such frequency component computation include a detection method which calculates inter-pixel difference values in the horizontal and vertical directions.

The horizontal compression unit 133 is configured from a compressing circuit which applies compression to a plurality of image data in the horizontal direction. One example of the compression scheme is a compression method for computing Hadamard transform in the horizontal direction and for encoding the computation result.

The vertical compression unit 134 is constituted from, a compressing circuit which applies compression to a plurality of image data in the vertical direction. One exemplary compression method includes the steps of setting the image data of a prescribed number of pixels—i.e., 2 lines in the vertical direction and 16 pixels in the horizontal direction—as the unit of the image data to be compressed, calculating a difference in the vertical direction, and next calculating a difference in the horizontal direction. The compression scheme used therein is arranged to encode a result of such processing.

Compression ratios of the horizontal compression unit 133 and vertical compression unit 134 may be arranged to employ a compression scheme capable of compressing the original image data to an extent that the compressed image data is about ⅔ to ½ of the original data (however, the present invention is not limited to this compression ratio).

The unit of the image data to be compressed by the above-stated horizontal compression unit 133 and vertical compression unit 134 is arranged to have a certain number of pixels, which number is determined to lessen the amount of a delay occurring due to the compression processing. Although the explanation was given by taking the case of 32 pixels as one example of the unit of the image data to be compressed, the unit may be replaced with a cluster of 64 pixels or 128 pixels.

A selector unit 135 selects, in accordance with a detection result of the above-stated correlativity detection unit 132, an output of the horizontal compression unit 133 or the vertical compression unit 134 and supplies it to an error correction code generation unit 136. The selector unit 135 may alternatively be arranged to compare output data amounts of the horizontal compression unit 133 and vertical compression unit 134 and selects a smaller one in place of the detection result of the correlativity detection unit 132.

The error correction code generation unit 136 computes an error correction code with respect to the unit of the image data to be compressed and outputs the compressed image data and error correction code to an encoding unit 137. One known error correction scheme is a CRC (Cyclic Redundancy Check) scheme or a parity check scheme.

The encoding unit 137 outputs the compressed image data within an effective period 406 of before-compression image data to be later described and outputs in a horizontal blanking period 404 subsequent thereto a flag indicative of the compression scheme and error correction code. Another approach is as follows: in cases where all of the compressed image data corresponding to one line and the flag indicating the compression scheme and the error correction code are sendable together within effective period 406 of one line, these may be transmitted together within the effective period 406.

An output part 138 outputs the compressed image data supplied from the encoding unit 137 along with the flag indicating the compression scheme and the error correction codes.

An input part 131 performs switching of each block's control mode or else in accordance with the control signal of control unit 110.

The above-stated configuration becomes small-scale circuitry because it does not require any complicated arithmetic processing; thus, it is possible to achieve additional functions of error correction codes at low costs.

FIG. 3 is a diagram showing code examples of compression models. A compression model indicates the compression scheme for use in the compression processing unit 114, wherein there are a horizontal compression unit 133 and a vertical compression unit 134. The Compression model code is a signal for indicating which one of compression schemes is used to compress the image data of interest. In a case where compression is performed by the horizontal compression unit 133, it indicates “0”; in case the compression is done by the vertical compression unit 134, it indicates “1.”

FIG. 4 is a block diagram showing one example of a configuration of the error correction code generation unit 136. To an input part 150, compressed image data is inputted. The compressed image data is inputted to a delay unit 152 and an error correction code adder unit 151 This error correction code adder unit 153 performs cyclic computation by means of a generating polynomial with respect to the input compressed image data.

One example of the generating polynomial is as follows:

G(X)=(X¹⁶+X¹²+X⁵+1. (MATH. 1)

This generating polynomial is for calculating an exclusive-OR (XOR) for each bit in the input image data, thereby performing the cyclic computation. The unit of such computation is set to the unit of the image data to be compressed.

An input part 151 receives an input signal indicative of a period in which the compressed image data is being input, which signal is supplied to a timing generator unit 154. The timing generator unit 154 counts compressed image data effective periods and outputs a signal indicating that the computation corresponding to the unit of the image data to be compressed has been processed, which signal is sent to a data retention unit 155 as a data retention signal.

The data retention unit 155 inputs digital data and data retention signal and retains the input digital data at the timing that the data retention signal becomes effective. The data retention signal is a signal from the timing generator unit 154; the digital data is a computation result from the error correction code adder unit 153.

The delay unit 152 is a delay circuit for adding a delay time occurring due to the processing of the error correction code adder unit 153 and data retention unit 155 to a data path of from the input part 151 to the output part 156. One example of the delay unit 152 is a flip-flop, a delay element or else.

An output of the delay unit 152 is outputted from the output part 156. An output of the data retention unit 155 is outputted from an output part 157.

An output from the output part 156 is outputted within the effective period 406 in which image data to be later stated in conjunction with FIG. 6 is sent out. An output from the output part 157 is outputted in the horizontal blanking period 404 in which the image data to be likewise stated in conjunction with FIG. 6 is not sent out.

FIG. 5 is a block diagram showing one example of a configuration of the data transfer unit 115.

An input part 170 outputs the compressed image data to a serializer 174. Additionally, an input part 172 inputs a clock of image data and outputs it to PLL 173 and output part 177.

The PLL 173 generates a clock obtained by applying frequency division or multiplication to the input clock. One example of the multiplication is a fivefold increase or tenfold increase with respect to the frequency of the input clock. The clock that is generated by PLL 173 may be a single kind of clock or, alternatively, two kinds of clocks. An example of the one-kind clock is 10-multiplication of the input clock. An example of the two-kind clock is a clock having a first clock rate which prioritizes the data transfer amount and a second clock rate which is a speed lower than the first clock rate and which prioritizes the reduction of an error occurrence frequency. Examples of the rate include setting the first clock rate to 10-multiplication of the input clock and setting the second clock rate to 5-multiplication of the input clock.

The multiplied clock that was generated by the PLL 173 is outputted to the serializer 174. The serializer 174 serializes the compressed image data of RGB or YUV of the input image data by a 10-multiplied clock into three 1-bit data streams respectively, which will be output to a level conversion unit 175.

One example of the serialization is to output 8-bit RGB/YUV image data in an order of MSB or LSB from the forefront or “head” by using a 10-multiplied clock.

The level conversion unit 175 outputs a signal of the format suitable for cable transmission via an output part 176. One example of the format suitable for the standardized cable transmission includes a signal format of TDMS differential level. In this format, there is no need to send any image data within the blanking period of an image; so, the data to be serialized by the serializer 174 is handled so that only 4-bit components in the 10-multiplied clock are used while avoiding the use of the remaining 6-bit components, thereby making it possible to increase the strength against transmission errors and transmit those data other than the image data.

In addition, the use of two kinds of clocks serves to reduce the clock that is generated by PLL 173 to ½ or less of the clock used to send the image data, thereby making it possible to obtain the same effect.

FIG. 6 is a diagram showing an effective area or “field” in which the image data of one frame period is superimposed and a blanking period in which the image data is not superimposed.

An area indicated by numeral 400 shows a vertical period: the vertical period 400 is constituted from a vertical blanking period 401 and vertical effective period 402. In the vertical blanking period, there is a VSYNC signal as vertical blanking signal. The VSYNC signal is a 1-bit signal which is set at “1” between a certain number of lines defined from the head of the vertical blanking period 401 and at “0” between other vertical blanking periods and the vertical effective period 402. One example of the defined line number is four lines or else.

An area indicated by numeral 403 shows a horizontal period. The horizontal period 403 consists of a horizontal blanking period 404 and horizontal effective period 405. An HSYNC signal is a 1-bit signal which is set at 1 between a number of lines defined from the head of the horizontal blanking period 404 and at 0 between other horizontal blanking periods and the horizontal effective period 405. One example of such defined line number is forty pixels.

An effective period 406 indicates an area surrounded by the vertical effective period 402 and the horizontal effective period 405. To this period, the image data is assigned. Moreover, a blanking period 407 is an area surrounded by the vertical blanking period 401 and the period of horizontal blanking period 404.

In this embodiment having the arrangement stated above, the image data that was compressed within the effective period 406 is transmitted in the effective period 406; in such line's next horizontal blanking period 404, an error correction code of its preceding line is sent. Since a data stream with packetization of audio data and other adjunct data is transferred in the planking period 407, it is no longer necessary to send image data as in the effective period 406.

One example of a data transfer amount of the audio data is as follows: there is linear PCM audio (a maximum of 192 kHz/24 bits), the data transfer amount of which becomes about 4.6 Mbps. In contrast, one example of a data transfer amount of the image data is as follows: there is the 422 format having a display size of 1920 pixels and 1080 vertical lines, signal bit accuracy of 8 bits, and a signal format of brightness/color-difference, wherein the data transfer amount is 2 Gbps. In this embodiment, this image data is compressed to provide 1-Gbps data with its size being reduced twofold or 1.33-Gbps data with a ⅔-reduced size.

When comparing data transfer amounts per prescribed time interval of the audio data and image data, the audio data's transfer amount is less; thus, the audio data is packetized to permit settlement of a transmittable data amount which has been divided within horizontal blanking periods.

In addition, for the 10-multiplied clock being input to the serializer 174, all of 10 bits are not used as data, thereby enabling 4-bit restriction of the data to be transmitted.

A method for sending this audio data in the form of reliable packets within the horizontal blanking period 407 with respect to the effective period 406 of FIG. 6 is disclosed, for example, in JP-T-2005-514873.

With this arrangement, an error correction code is embedded in the packet data of the blanking period. Thus, it is possible to correct errors occurring on the transfer path, resulting in enhancement of the error tolerability. Additionally, the data for transmission of packet data of blanking periods are arranged to be transferred over physically different two channels while at the same time performing switching between transmission channels at predetermined time intervals whereby a burst-like error occurred on one channel does not affect the other channel so that it is possible to perform data error correction. Regarding the error correction rate, there is an improvement effect demonstrating that the horizontal blanking period is 10⁻¹⁴ whereas the horizontal effective period is 10⁻⁹.

One available approach to obtaining the above-stated packets of blanking periods is to packetize error correction codes. An example of the packet number will be explained in relation to a case where the pixel number of horizontal period is 2,200 and the pixel number of horizontal effective period is 1,920.

When the size of an image to be compressed is set to 64 pixels (32 pixels for the luminance, 32 pixels for color difference), the size of per-line error correction code (2 bytes) is required to be 120 bytes.

Since there is the capacity that can transfer 28 bytes per packet, if there are 5 packets, it becomes the size capable of being transmitted. As the horizontal blanking period is such that there are 280 pixels, 8 packets are superimposable. With this arrangement, it becomes possible to further send an error correction code in addition to an audio packet (one packet) within the horizontal blanking period.

With the arrangement stated above, the compressed image data increases in tolerability against errors occurring during data transmission, thus making it possible to perform error detection and error correction.

Also note that although not specifically depicted, the image reception device 200 is arranged to have a built-in ROM which stores therein an EDID (Enhanced Extended Display Identification Data) indicating the performance of image reception device 200. This ROM may also be designed so that the information for determining whether the image reception device 200 supports the compression/expansion capability. Whereby, the image transmission device 100 reads out of the ROM storing therein the EDID of image reception device 200 the information for determining whether it supports the compression/expansion and transmits the compressed image data if it is the device supporting the same or sends an uncompressed image having an ordinary size if it is a noncompliant device, thereby making it possible to preserve the compatibility with compression processing-noncompliant image reception devices also.

In addition, by displaying on the screen of display unit 208 the fact that the image receiving device fails to support the compression and that the image is of a conventional size, it is possible to give notice to the user.

In addition, in cases where the image transmission device 100 is used as a mobile device, it becomes battery-powered equipment; so, electrical power consumption of the image transmission device 100 affects the length of a continuous use time interval. In this case, the transmission of compressed image data serves to reduce the data transfer amount, resulting in a decrease in power consumption. This advantageous effect makes it possible to set an extended length of continuous use time interval by adding a function such as “power-save mode” for example as an operation mode of the image transmission device 100 and by transmitting non-compressed image data in a case where electric power is being supplied externally or, alternatively, sending the image data after having applied compression thereto in case the device is being battery-powered.

FIG. 7 is a block diagram showing one example of a configuration of the data reception processing unit 205.

An input part 220 receives a signal which was converted by the level conversion unit 175 of the image transmission device 100 and outputs it to a level conversion unit 222. The level conversion unit 222 converts the signal that was level-converted by the image transmission device 100 into a digital signal and outputs it to a deserializer 223. One example of the level conversion is to convert a differential signal into a single-end signal.

Another input part 221 inputs a clock which was outputted from the image transmission device 100 and outputs it to a PLL 224. The PLL 224 generates a clock which is ten times the input clock in the effective period 406 and, in the blanking period 404 also, generates a clock which is ten times the input clock in a similar way, then outputting it to the deserializer 223. The PLL 224 also operates to output a pixel clock for use in the image reception device 200 from an output part 226.

The deserializer 223 parallelizes the serialized data in sync with the clock from PLL 224 and outputs it from an output part 225. The deserializer 223 parallelizes all data of the tenfold clock in the effective period and, in the blanking period, uses only 4 bits of such tenfold clock.

FIG. 8 is a block diagram showing one example of a configuration of the expansion processing unit 206. FIG. 10 is a flow diagram showing the processing concept of the expansion processing unit 206.

An input part 250 is a data input section of the expansion processing unit 206. Data to be input to the input part 250 include HSYNC (FIG. 10(a)) and VSYNC indicating sync signals of image data, an image data that was compressed in the effective period 406, an error correction code of its preceding line in the horizontal blanking period 404, and a compression model code (FIG. 10(b)).

The HSYNC and VSYNC are supplied to a timing generator unit 251. The timing generator unit 251 uses the HSYNC and VSYNC inputted thereto to control a counter to thereby generate and output timings of the vertical blanking period 401, vertical effective period 402, horizontal blanking period 404, horizontal effective period 405 and effective period 406 and also timings required to control a selector unit 252, error detection/correction unit 255 and selector unit 261.

The compressed image data, line's error correction code and compression model code are supplied to the selector unit 252. The selector unit 252 is a selecting unit which separates the input data into two signals at a switching timing from the timing generator unit 251. The selector unit 252 outputs the input data to a code detection unit 253 in case the signal from the timing generator unit 251 is indicative of horizontal blanking period 404 and outputs, when the signal from timing generator unit 251 indicates effective period 406, the input data to a line memory 254. By this processing, an error correction code and compression model code 512, 514 are supplied to the code detection unit 253; the compressed image data 511, 513, 515 are supplied to the line memory 254.

The code detection unit 253 is a code detection unit which detects from the input data the error correction code and compression model code. The error correction code and compression model code exist per unit of the compressed image data; each is outputted to the error correction unit 255 (FIG. 10(c)). The compression model code is also output to a selector unit 258.

The line memory 254 is a line memory for delaying the compressed image data by one line and for outputting the one-line delayed data. An output of the line memory 254 is outputted to the error correction unit 255 (FIG. 10(d)).

The error correction unit 255 processes the image data inputted from the line memory 254 to compute, per unit of compressed image data, the same error correction code as that of the error correction code generation unit 136. After having compared the computation result and the error correction code to be input from the code detection unit 253, when a comparison result is different, error correction processing is performed. One example of such error correction processing is CRC operation.

Alternatively, only the error detection may be performed, and an error(s) may be interpolated by the processing to be later executed. An output of the error correction unit 255 is supplied to a horizontal expansion unit 256 and vertical expansion unit 257. The horizontal expansion unit 256 and vertical expansion unit 257 are expansion units which perform expansion processing of the compression scheme that is built in the image transmission device 100, for performing expansion to image data, and for outputting the data to the selector unit 258.

The selector unit 258 checks the compression model code to be supplied from the code detection unit 253 with respect to each unit of the image data to be compressed: if its value is “0,” then select the output of the horizontal expansion unit 256; if the value is “1” then select the output from the vertical expansion unit 257 and output it to a selector unit 261, data retention unit 259 and second line memory 260.

The data retention unit 259 holds the horizontally continued image data and outputs it to the selector unit 261. The line memory 260 has the same function as the line memory 254, and outputs to the selector unit 261 an output which was obtained by one-line delaying the input data-given image data (FIG. 10(f).

The selector unit 261 is a selecting unit which selects one from among three input image data. The selector unit 261 determines in response to the signal from the error correction unit 255 which one of these data is selected and outputted. The selector unit 261 selects the image data from the selector unit 258 in cases where the signal from the error correction unit 255 indicates the absence of errors. In a case where the signal from the error correction unit 255 indicates the presence of an error(s) and simultaneously it is compressed in the horizontal direction, the selector selects the right-hand neighboring data being stored in the data retention unit 259; in case it is compressed in the vertical direction, it selects one-line preceding data stored in the line memory 260 (FIG. 10(e)).

With this arrangement, it is possible to achieve replacement with high-correlativity image data even in cases where errors take place; so, it is possible to lessen the influence on images due to transmission errors. In addition, the range of those pixels to be replaced is appreciably reduced because the unit of the image data to be compressed is ten-odd pixels; thus, it is possible to lessen the influence of transmission errors. It is also possible to suppress the delay of compression/expansion processing by use of a one line as shown in FIG. 10(e).

In accordance with the above-stated illustrative embodiment, it becomes possible by compressing for transmission the image data to be sent by image transmission device to transmit to a presently defined transfer path the image data with its size greater than the presently defined image size. Furthermore, it is possible to perform error tolerability-enhanced image transmission by adding error detection and correction codes to those areas with increased error tolerability.

In the case of transmitting image data having the currently defined image size, it is possible to lower the data transmission amount per fixed time interval or the data transmission clock. This makes it possible to lower the error occurrence frequency and establish a system offering high reliability against errors occurrable on transmission paths.

It also possible to realize a system which performs error processing with error-caused image quality degradation being made indistinctive even in cases where errors occurred on transmission paths cannot be corrected completely.

Although the description presented above is made with respect to particular illustrative embodiments of this invention, it will be understood by those skilled in the art that various changes and alterations may be made therein without departing from the spirit and scope of the invention.

### REFERENCE SIGNS LIST

100 Image Transmission Device

101, 102, 103, 104, 130, 131, 150, 151, 170, 172, 201, 202, 220, 221, 250 Input Part

105 Tuner Reception Processing Unit

106 Network Reception Processing Unit

107 Recording Media Control Unit

108 Recording Media

109, 203 User IF

110, 204 Control Unit

111 Stream Control Unit

112 Decoder

113, 207 Display Processing Unit

114 Compression Processing Unit

115 Data Transfer Unit

116, 138, 156, 157, 176, 177, 225, 226, 262 Output Part

200 Image Reception Device

205 Data Reception Processing Unit

206 Expansion Processing Unit

208 Display Unit

223 Deserializer

253 Code Detection Unit

254, 260 Line Memory

255 Error Correction Unit

256 Horizontal Expansion unit

257 Vertical Expansion unit

259 Data Retention Unit

300 Cable

132 Correlativity Detection Unit

133 Horizontal Compression Unit

134 Vertical Compression Unit

135, 252, 258, 261 Selector Unit

136 Error Correction Code Generation Unit

137 Encoding Unit

152 Delay Unit

153 Error Detection Flag Adder Unit

154, 251 Timing Generator Unit

173, 224 PLL

174 Serializer

175, 222 Level Conversion Unit

400 Vertical Period

401 Vertical Blanking Period

402 Vertical Effective Period

403 Horizontal Period

404 Horizontal Blanking Period

405 Horizontal Effective Period

406 Effective Period

407 Blanking Period

501, 502, 503, 504 Unit of Image Data to be Compressed

511, 513, 515 Compressed Image Data

512, 514 Error Correction Code and Compression Model Code

1. An image transmission device which compresses and transmits an image data comprising:
a compression processing unit which compresses the image data;
an error correction code generation unit which computes an error correction code with respect to compressed image data; and
an output unit which outputs the compressed image data and the error correction code,
wherein a period in which the compressed image data is outputted and a period in which the error correction code is outputted are different periods.

2. The image transmission device as recited in claim 1, wherein a data transmission amount of the period in which the compressed image data is outputted is greater than a data transmission amount of the period in which the error correction code is outputted.

3. The image transmission device as recited in claim 2, wherein the period in which the error correction code is outputted is a horizontal blanking period.

4. The image transmission device as recited in claim 2, wherein the compression unit includes a detection unit which detects correlativity of horizontal and vertical directions of image data, a horizontal compression unit which performs compression processing in the horizontal direction, a vertical compression unit which performs compression processing in the vertical direction, and a selector unit which outputs either one of an output of the horizontal compression unit and an output of the vertical compression unit along with a code indicative of compression scheme, and that
the output of the selector unit is controlled in accordance with an output of the detection unit.

5. An image transmission method which compresses and transmits image data comprising:
a step of compressing image data;
a step of computing an error correction code with respect to compressed image data; and
a step of outputting the compressed image data and the error correction code,
wherein a period in which the compressed image data is outputted and a period in which the error correction code is outputted are different periods.

6. The image transmission method as recited in claim 5, wherein a data transmission amount of the period in which the compressed image data is outputted is greater than a data transmission amount of the period in which the error correction code is outputted.

7. The image transmission method as recited in claim 6, wherein the period in which the error correction code is outputted is a horizontal blanking period.

8. The image transmission method as recited in claim 6, characterized by further comprising:
a step of computing an error correction code with respect to data of the period for output of the error correction code.

9. The image transmission method as recited in claim 6, wherein the compression processing includes:
detecting that the image data to be compressed is which one of image data with its correlativity being higher in horizontal direction and image data with its correlativity being higher in vertical direction,
selecting based on a detection result of the correlativity either one of horizontal compression processing and vertical compression processing, and
outputting a signal indicating that compression has been done by either compression processing.

10. An image receiving device which receives a compressed image data comprising:
an input unit which receives the compressed image data and an error correction code;
an error correction unit which corrects an error of the compressed image data based on the error correction code thus received;
an expansion unit which expands the compressed image data corrected by the error correction unit; and
an output unit which outputs the image data expanded by the expansion unit,
wherein a period in which the compressed image data is transmitted and a period in which the error correction code is transmitted are different periods.

11. The image receiving device as recited in claim 10, wherein a data transmission amount of the period in which the compressed image data is transmitted is greater than a data transmission amount of the period in which the error correction code is transmitted.

12. The image receiving device as recited in claim 11, wherein the period in which the error correction code is transmitted is a horizontal blanking period.

13. The image receiving device as recited in claim 11, wherein the expansion unit includes a detection unit which detects a code indicative of compression scheme, a horizontal expansion unit which performs an expansion processing in a horizontal direction, a vertical expansion unit which performs an expansion processing in a vertical direction, and a selector unit for outputting either one of an output of the horizontal expansion unit and an output of the vertical expansion unit, and that the output of the selector unit is controlled based on a detection result of the detection unit.

14. An image receiving method comprising:
a step of inputting compressed an image data and an error correction code;
a step of correcting an error of the compressed image data based on the input error correction code;
a step of expanding the error-corrected compressed image data; and
a step of outputting the expanded image data,
wherein a period in which the compressed image data is transmitted and a period in which the error correction code is transmitted are different periods.

15. The image receiving method as recited in claim 14, wherein a data transmission amount of the period in which the compressed image data is transmitted is greater than a data transmission amount of the period in which the error correction code is transmitted.

16. The image receiving method as recited in claim 15, wherein the period for transmission of the error correction code is a horizontal blanking period.

17. The image receiving method as recited in claim 15, wherein the expansion processing includes horizontal expansion processing which performs an expansion processing in a horizontal direction and vertical expansion processing which performs an expansion processing in a vertical direction and that either one of the horizontal expansion processing and the vertical expansion processing is performed based on a code indicative of a detected compression scheme.
